(19) United States
(12) Patent Application Publication
(10) Pub. No.: US 2017/0091416 A1
(43) Pub. Date: Mar. 30, 2017

(54) METHOD, SYSTEM, AND APPARATUS FOR IMPROVING LIKELIHOOD OF FIRST-FILL OF A MEDICATION PRESCRIPTION

(71) Applicant: McKesson Corporation, San Francisco, CA (US)

(72) Inventors: Steve Mink, Cave Creek, AZ (US); Derek Rago, Scottsdale, AZ (US)

(21) Appl. No.: 15/084,618

(22) Filed: Mar. 30, 2016

Related U.S. Application Data
(60) Provisional application No. 62/235,137, filed on Sep. 30, 2015.

(51) Int. Cl. G06F 19/00

(52) U.S. Cl. CPC G06F 19/3456; G06F 19/328

(57) ABSTRACT

A system for providing improved first-fill prescription adherence may include a dispensing pharmacy apparatus configured to receive prescription information from a care professional. The system may also include a non-dispensing pharmacy apparatus configured to access the prescription information at the dispensing pharmacy. The non-dispensing pharmacy apparatus may analyze the prescription information to determine if any necessary information is missing, and provide a request for any missing information. The non-dispensing pharmacy apparatus may further communicate prescription information to an insurance provider, receive insurance provider approval and co-pay information, and execute a co-pay offset application to determine if co-pay offset benefits are available. A corresponding method is also provided.

### CROSS-REFERENCE TO RELATED APPLICATIONS

This application is a non-provisional conversion of and claims priority to Provisional Application Ser. No. 62/235,137, filed on Sep. 30, 2015, the contents of which are herein incorporated by reference in their entirety.

### TECHNOLOGICAL FIELD

Embodiments of the present invention relate generally to health care management solutions and, more particularly, relate to the provision of a mechanism by which to improve medication adherence for patients by helping a patient to receive their first fill of a prescription while managing the various systems, programs, and providers involved in an initial first fill of a prescription, and subsequent prescription refills, thereby lessening the burden and complexity for a patient.

### BACKGROUND

Modern healthcare has developed countless medications and therapies for curing, remediating, or managing an ever-growing list of medical ailments. However, in order for a patient to receive the benefits of prescribed medications and therapies, the prescription must first be filled and used by the patient. Studies have shown that up to a third of patients fail to fill first-time prescriptions, such that these patients may not resolve their medical ailments, and their health may deteriorate as a result. Long-term effects of failing to fill a prescription may include worsening ailments and higher cost healthcare required to restore the patient to health, including possible hospitalization which may increase healthcare costs exponentially.

Patients may have various reasons for not initially filling a prescription ranging from cost to inconvenience to forgetting to fill a prescription, particularly if symptoms are non-debilitating or generally undetectable (e.g., high blood pressure). In the interest of improving a patient's health and reducing potential long-term costs of care, it is desirable to facilitate the initial first-fill of a prescription of a patient.

### BRIEF SUMMARY

A method, apparatus and computer program product are therefore provided to overcome various barriers in the initial, first fill of a prescription for a patient. According to an example embodiment, a pharmaceutical prescription integration system may be provided. The system of various embodiments may include a dispensing pharmacy apparatus configured to receive prescription information from a care professional. The system may also include a non-dispensing pharmacy apparatus configured to access the prescription information at the dispensing pharmacy. The non-dispensing pharmacy apparatus may be configured to analyze the prescription information to determine if any necessary information is missing, and provide a request for any missing information. The non-dispensing pharmacy apparatus may further be configured to communicate prescription information to an insurance provider, receive insurance provider approval and co-pay information, and execute a co-pay offset application to determine if co-pay offset benefits are available.

According to some embodiments, the non-dispensing pharmacy apparatus may further be configured to provide prescription approval information to the dispensing pharmacy; and provide co-pay information and co-pay offset benefit information to the dispensing pharmacy. The non-dispensing pharmacy apparatus may optionally be configured to provide outbound communication to the patient regarding out-of-pocket costs of the prescription and to secure patient payment information. Furthermore, adherence messaging, refill reminders and details regarding the fulfillment schedule of the prescription will also be provided. According to some embodiments, the apparatus may be configured to receive an indication that prior authorization is required for the prescription, and provide communication to the care professional regarding the required prior authorization.

According to some embodiments, the co-pay offset application may analyze the prescription information and determine if a third party entity program is available to pay for at least a portion of the co-pay. The non-dispensing pharmacy apparatus may further be configured to provide confirmation to the dispensing pharmacy apparatus that the prescription is to be filled. The request for any information determined to be missing may include providing a portal for entry of the information determined to be missing via a graphical user interface. The non-dispensing pharmacy apparatus may be configured to receive an indication of refusal from the insurance provider, and provide authorization for an initial fill in response to the refusal from the insurance provider. In response to the refusal from the insurance provider, the non-dispensing pharmacy apparatus may be configured to provide an indication to a third party service of the refusal from the insurance provider, and receive from the third party service an indication of an amount of assistance available to offset a cost of the prescription.

Embodiments of the present invention may provide a method for improving first-fill compliance with a prescription. Methods may include receiving prescription information including an identification of the medication type, a medication dosage, and a patient identifier. Methods may analyze the prescription information to establish any information necessary for fulfillment of the prescription that is not present or invalid. According to some embodiments, the method may provide for communication of prescription information to an insurance provider, receive insurance provider approval and co-pay information, and execute a co-pay offset application to determine if co-pay offset benefits are available and patient eligibility.

According to some embodiments, the method may optionally include providing prescription approval information to a dispensing pharmacy, and providing co-pay information and co-pay offset benefit information to a dispensing pharmacy. Methods may include providing outbound communication to the patient regarding out-of-pocket costs related to the prescription and to secure patient payment information. Furthermore, adherence messaging, refill reminders and details regarding the fulfillment schedule of the prescription will also be provided. Methods may include receiving an indication that prior authorization is required for the prescription, and providing communication to the care professional regarding the required prior authorization. Methods may include providing a notification to a patient associated with the patient identifier of a need for additional information in response to establishing at least some information necessary for prescription fulfillment is not present or invalid. The notification may include a portal through which the patient may provide the additional information.

Embodiments of the present invention may provide an apparatus having at least one processor and at least one non-transitory memory having computer program code stored therein. The apparatus may be configured, in response to execution of the program code, to: receive prescription information associated with a prescription, where the prescription information includes at least a patient identifier and a medication identifier; determine if any information needed for fulfilling the prescription is not present in the prescription information; provide an indication to an insurance provider associated with the patient identifier of the prescription information; receive an indication from the insurance provider regarding eligibility and co-pay amount; assess co-pay assistance benefits of one or more third party assistance programs; and provide instruction to a dispensing pharmacy to fill the prescription.

According to some embodiments, the apparatus may be configured to provide a notification to the patient in response to any information needed for fulfilling the prescription not being present in the prescription information. The apparatus may be configured to provide an indication to the patient of an out-of-pocket cost associated with the prescription in response to the co-pay amount provided by the insurance provider and the co-pay assistance benefits of the one or more third party assistance programs. The apparatus may optionally be configured to receive an indication from the insurance provider that prior authorization is required for the prescription, and provide communication to a health care professional regarding the required prior authorization.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for providing improved first-fill prescription response according to an example embodiment of the present invention;

FIG. 2 is a block diagram showing various components that may be included in an apparatus for providing improved first-fill prescription response according to an example embodiment of the present invention;

FIG. 3 is a block diagram according to a method for providing improved first-fill prescription response according to an example embodiment of the present invention; and

FIG. 4 is a block diagram according to another method for providing improved first-fill prescription response according to an example embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, embodiments of the present invention are aimed at providing a mechanism by which to improve engagement with patients for medication adherence. Some example embodiments may assist a patient to receive their first fill of a prescription while managing the various systems, programs, and providers involved in an initial first fill of a prescription, thereby lessening the burden and complexity involve in prescription fills for a patient.

Failures in medication adherence can be very costly to the health care industry. Failure to take medications in accordance with instructions may obviously cause wastage with respect to medications not taken or not taken in a manner that is likely to be effective. Failure to initially fill a prescription when it is first prescribed will prevent a patient from benefiting from the effects of the prescribed meditation. The costs of failures in medication adherence also extends to cover the costs of complications that arise from failure to adhere and/or the costs of recurrence or lingering of illness and the subsequent treatments that may continue or even expand. In some cases, failures in medication adherence can be traced to a failure to even pick up a prescription that has been received, and sometimes even filled, at a pharmacy and is waiting for the patient to come in to pick up the prescription. Thus, data generated by the pharmacy may indicate that a prescription has been received by the pharmacy and perhaps also filled. If the patient fails to arrive to pick up the prescription, and therefore abandons the prescription, this wastage may be a direct cost that could be avoided. Moreover, more indirect costs (e.g., complications from not taking the medication or exacerbation of the patient's condition) may be avoided as well since it is more likely that the patient will take a medication that the patient has already gone through the effort of acquiring.

A patient may fail to initially fill a prescription due to a variety of potential barriers that may discourage the patient from completing the first fill. Such barriers may include a financial barrier in which a patient may not initially fill a prescription due to patient out-of-pocket costs. The patient may perceive or be informed of a prescription cost that exceeds what they are able or willing to pay, without recognizing that there may be alternative solutions that can reduce the out-of-pocket expenses. Out-of-pocket expenses for a medication can be reduced or offset with co-pay offset benefits that may be available through their doctor, their insurance provider, the medication supplier, or a third-party assistance program.

Another barrier a patient may encounter or perceive is a clinical barrier in which a patient may be intimidated by potential side effects, dosing complexity, or a negative perception of effectiveness. A behavioral barrier may further preclude a patient from initially filling a prescription. A behavioral barrier may include a patient that is unwilling to admit the medication is needed, a patient may be too embarrassed to fill a prescription for one reason or another, or a patient may simply be too busy or preoccupied to remember to fill a prescription. Each of these barriers needs to be overcome in order to improve the success of a prescribed medication by assisting a patient in getting the prescription filled a first time.

Some example embodiments may therefore provide a mechanism to improve the likelihood of a patient initially filling a prescription after a care professional visit. In this regard, some example embodiments may provide a system that reduces the complexity of filling a new prescription for a patient and provides assistance in encouraging the patient to first fill the prescription to ultimately improve medication adherence and reduce overall healthcare costs.

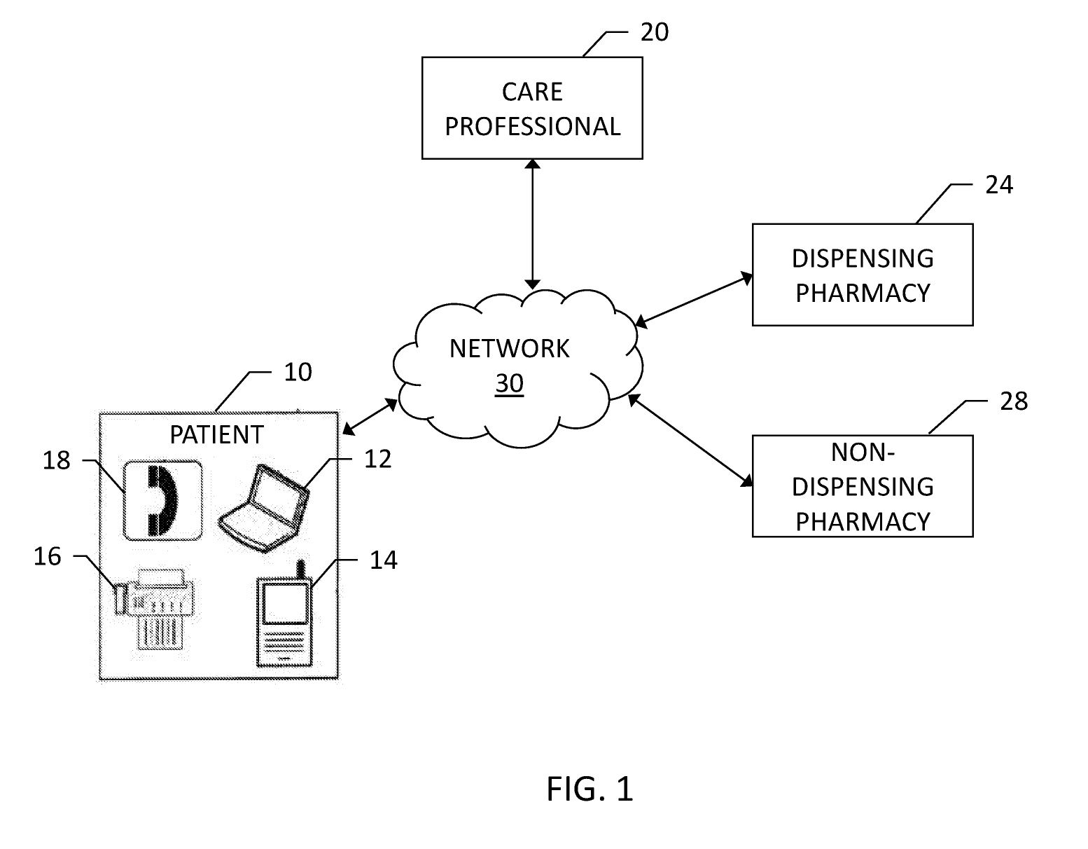

An example embodiment will now be described in reference to FIG. 1, which illustrates an example system in which an embodiment of the present invention may be employed. Of note, the example of FIG. 1 is provided to illustrate several, but not all examples of devices and system architectures that may employ example embodiments. Thus, some examples may include more or less components than those which are shown in FIG. 1. As shown in FIG. 1, a system according to an example embodiment may include one or more patients (e.g., patient 10) that may, in some cases, be reachable via various different modes of communication. For example, the patient 10 may have a personal computer (PC) or laptop computer 12 via which email messages or other multimedia messages may be received. Alternatively or additionally, the patient 10 may have a mobile telephone, personal digital assistant or other mobile communication device 14 that may receive phone calls, text messages, emails or other communications. The patient 10 may also or alternatively be reachable by fax machine 16 or via landline telephone 18. As such, with respect to phone calls and various types of electronic messaging, the patient 10 may generally be reachable by sending messages over a network 30 or receiving voice phone calls over the network 30.

The network 30 may be a data network, such as a local area network (LAN), a metropolitan area network (MAN), a wide area network (WAN) (e.g., the Internet), and/or the like. However, in some cases, the network 30 may be a wired or wireless telephone network. As such, communication between the network 30, the patients and the other devices or databases (e.g., servers) to which the network 30 may be coupled can be accomplished by either wireline or wireless communication mechanisms and corresponding protocols.

In some embodiments, the network 30 may also be connected to, or be capable of providing a connection to, a care professional 20 such as a doctor's office, hospital, pharmacy, insurance provider, care manager, or other healthcare related service professional. The care professional 20 may also have access to one or more of the modes of communication described above. The care professional 20 may also be associated with one or more different communication devices that may be used to contact the care professional 20 in connection with example embodiments and/or provide information to the care professional 20 about one or more patients.

According to some embodiments, the network 30 may also be connected to or be capable of providing a communication connection to a dispensing pharmacy 24 and a non-dispensing pharmacy 28. A dispensing pharmacy 24 may be a licensed pharmacy that provides various services to a patient, such as dispensing prescription medications. A dispensing pharmacy may be embodied by a retail pharmacy, a mail-order pharmacy, or a specialty pharmacy, for example. A non-dispensing pharmacy 28 may be a licensed pharmacy including a licensed pharmacist, and may provide most, but not all, services of a dispensing pharmacy. A non-dispensing pharmacy 28 may facilitate patient communication, prescription claims support and resolution, engagement into other sponsored support programs, and behavioral call center services, for example. Unlike a dispensing pharmacy 24, a non-dispensing pharmacy 28 does not stock prescription drugs or dispense prescription medication to patients.

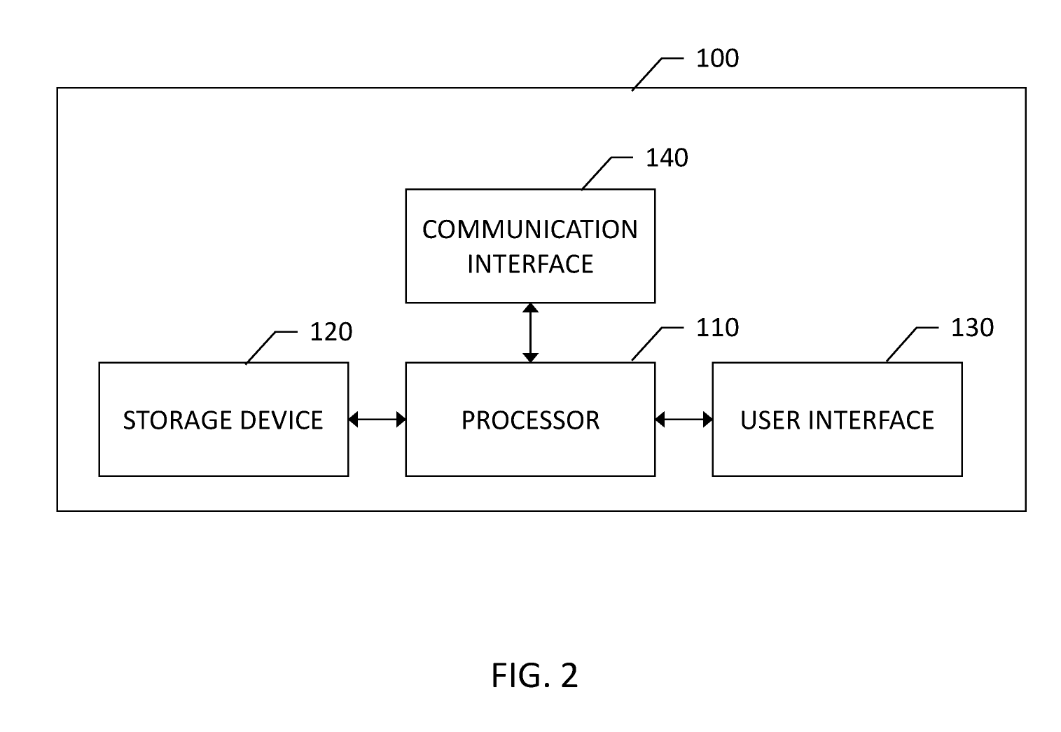

FIG. 2 illustrates certain elements of an apparatus 100 which may be part of the dispensing pharmacy 24 and/or the non-dispensing pharmacy 28. The apparatus of FIG. 2 may be employed, for example, on any of a variety of devices, such as a network device, server, proxy, desktop computer system, laptop computer, or the like. Optionally, embodiments may be employed on a combination of devices. Accordingly, some embodiments of the present invention may be embodied wholly at a single device (e.g., non-dispensing pharmacy 28) or by devices in a client/server relationship (e.g., the apparatus of FIG. 2 and one or more clients distributed through the network 30). It should be noted that the devices or elements described below may not be mandatory and thus some may be omitted in certain embodiments.

The apparatus 100 of FIG. 2 for facilitating prescription first fill compliance is provided. The apparatus may include or otherwise be in communication with processing circuitry, such as processor 110, that is configured to perform data processing, application execution and other processing and management services according to an example embodiment of the present invention. According to an example embodiment, the processing circuitry may include a storage device 120, and may be in communication with or otherwise control a user interface 130. As such, the processing circuitry may be embodied as a circuit chip (e.g., an integrated circuit chip) configured (e.g., with hardware, software, or a combination of hardware and software) to perform operations described herein. However, in some embodiments, the processing circuitry may be embodied as a portion of a server, computer, laptop, workstation, or various mobile computing devices. In embodiments in which the processing circuitry is embodied as a server or at a remotely located computing device, the user interface 130 may be disposed at another device (e.g., at a computer terminal or client device) that may be in communication with the processing circuitry via communication interface 140 and/or a network (e.g., network 30).

The user interface 130 may be in communication with the processing circuitry to receive an indication of a user input at the user interface 130 and/or to provide an audible, visual, mechanical or other output to the user. As such, the user interface 130 may include, for example, a keyboard, a mouse, a joystick, a display, a touch screen, a microphone, a speaker, and/or other input/output mechanisms. In an example embodiment in which the apparatus is embodied as a pharmacy (e.g., the non-dispensing pharmacy 28) or some other network devices, the user interface 130 may be fully implemented, limited, remotely located or eliminated.

The apparatus 100 may include one or more communication interfaces 140 for enabling communication with other devices and/or networks. In some cases, the communication interface 140 may be any means such as a device or circuitry embodied in either hardware, or a combination of hardware and software that is configured to receive and/or transmit data from/to a network and/or any other device or module in communication with the processing circuitry. In this regard, the communications interface 140 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the storage device 120 may include one or more non-transitory memory devices such as, for example, volatile and/or non-volatile memory that may be either fixed or removable. The storage device 120 may be configured to store information, data, applications, instructions or the like for enabling the apparatus to carry out various functions in accordance with example embodiments of the present invention. For example, the storage device 120 could be configured to buffer input data for processing by the processor 110. Additionally or alternatively, the storage device 120 could be configured to store instructions for execution by the processor 110. As yet another alternative, the storage device 120 may include one of a plurality of databases that may store a variety of files, contents or data sets. Among the contents of the storage device 120, applications may be stored for execution by the processor 110 in order to carry out the functionality associated with each respective application.

The processor 110 may be embodied in a number of different ways. For example, the processor 110 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 110 may be configured to execute instructions stored in the storage device 120 or otherwise accessible to the processor 110. As such, whether configured by hardware or software methods, or by a combination thereof, the processor 110 may represent an entity (e.g., physically embodied in circuitry) capable of performing operations according to embodiments of the present invention while configured accordingly. Thus, for example, when the processor 110 is embodied as an ASIC, FPGA or the like, the processor 110 may be specifically configured hardware for conducting the operations described herein. Alternatively, as another example, when the processor 110 is embodied as an executor of software instructions, the instructions may specifically configure the processor 110 to perform the operations described herein.

In an example embodiment, the processor 110 may be embodied as, include or otherwise control the communication interface 140. The communication interface 140 may be configured to access information from various sources and utilize the information to select a communication plan for sending targeted messaging for communicating with a patient, an insurance provider, a dispensing pharmacy, a care provider, etc. The communication plan may define the communication channel or mechanism to be used to communicate with the target of the communications as well as the timeframes at which communication will be generated, and may access stored contact information associated with the target to contact the target accordingly. In some cases, the communication plan may define a preferred contact method for each respective target, or may default to predefined methods if no preferences are provided. For example, if a patient has provided information supportive of only one contact method (e.g., only providing an email address), then the corresponding contact method may obviously be employed. However, if the patient has provided information supportive of multiple contact methods (e.g., email, phone number, fax number, etc.), then a preferred or default one of the multiple contact methods may be selected for contacting the patient.

An example embodiment of a system to improve first filling of a prescription by a patient may begin with a participating physician that may generate a prescription for a patient. The prescription may be generated through an electronic system, such as using an electronic health record (EHR) system or any form of prescription system configured to receive prescription information related to a patient, a medication, and a prescribed dosage. Optionally, the prescription may be handwritten by a physician. The physician or nurse or a staff member may route the prescription (e.g., from care professional 20 via network 30) to a dispensing pharmacy 24, where the prescription and patient information may then be processed.

The care professional 20 (nurse, doctor, staff member, etc.) may route the prescription to the dispensing pharmacy 24 or the non-dispensing pharmacy 28 through a number of communication mechanisms. For example, the prescription may be routed via network 30 by an EHR system, an electronic prescription system, electronic messaging, etc. to the dispensing pharmacy 24. Optionally, the prescription may be sent via fax or called in to the dispensing pharmacy or non-dispensing pharmacy and manually entered into a prescription order system at the pharmacy. The prescription may include information related to a medication, a dosage, and patient identifying information.

According to example embodiments described herein, the non-dispensing pharmacy 28 may access the apparatus of the dispensing pharmacy 24, e.g., via communication interface 140, and access the prescription information, which may be stored, for example, on storage device 120. The non-dispensing pharmacy 28 may process the prescription information (e.g., via a processor 110 of apparatus 100) and may identify any information that is necessary to fill the prescription but not present in the prescription information. For example, insurance plan information may not be included with the prescription information.

Any information necessary for processing the prescription that is missing from the prescription information may trigger patient outreach in order to obtain the missing information. Patient outreach may include a phone call to the patient, email correspondence to the patient (e.g., with a link to a network portal in which missing information may be entered), text message (e.g., including a phone number to call when convenient), fax communication, etc. The mechanism for communication with the patient may be determined as described above via communication interface 140 and the appropriate contact with the patient may then be made. Once the missing information is received, whether entered via a patient portal or received via telephone and entered at the non-dispensing pharmacy 28, the non-dispensing pharmacy 28 may communicate with various providers in order to determine how the cost of the prescription is to be handled, and whether the appropriate approvals are in place in order to fill the prescription.

The apparatus 100 of the non-dispensing pharmacy 28 may contact the insurance provider to determine the portion of the prescription cost covered by the insurance provider. The method of contact may be determined, as described above, by the communication interface 140 according to a preference established between the non-dispensing pharmacy 28 and the insurance provider. Absent a communication preference, a default communication channel may be used, such as a voice phone call during which a communication preference may be established. The insurance provider may require prior authorization for a medication before the prescription can be first filled. In such an instance, the apparatus 100 of the non-dispensing pharmacy 28 may be informed of the prior authorization requirement and may be provided with the necessary form that may be required to be completed by a prescribing physician or designee thereof. The prior authorization requirement is often a barrier that may preclude a patient from filling a prescription as the process may appear daunting or tedious. According to example embodiments described herein, the non-dispensing pharmacy 28 may communicate the prior authorization requirement to the care provider 20 and obtain the necessary authorization without requiring input from a patient, thereby removing the prior authorization barrier that precludes some patients from filling a prescription.

The apparatus 100 of the non-dispensing pharmacy may further execute a co-pay finder application (e.g., via processor 110) to determine a patient's eligibility and co-pay amounts to determine the various reimbursement paths to assist the patient in successfully beginning their therapy with the first prescription fill. The co-pay finder application may involve establishing a co-pay requirement according to the patient's primary care insurance provider and determining if any supplemental insurance is in place to assist with co-pay premiums.

In an example embodiment in which an insurance provider may cover the cost of a prescription in its entirety, or with a very minimal co-pay (e.g., $10 or less), the non-dispensing pharmacy 28 may provide an alert or information to the dispensing pharmacy 24 that the prescription is ready for immediate dispensing.

In an example embodiment in which an insurance provider may cover less than the cost of the prescription, a co-pay offset application may be executed to determine patient eligibility for any co-pay offset benefits, such as drug maker loyalty programs, discount programs, third party coverage options, etc. According to some embodiments, the co-pay offset application may be used simultaneously with the prescription being filled by a dispensing pharmacy 24 to reduce latency of the prescription being filled. Co-pay offset benefits may not be necessary to fill a prescription, such that latency introduced while researching potential co-pay offset benefits may be undesirable.

As described above, the non-dispensing pharmacy 28 may function as a patient advocate to facilitate advancing the prescription from the care provider 20 through the financial hurdles and approval requirements to the dispensing pharmacy 24 for dispensing to a patient, with minimal effort required by the patient to ensure that the prescription is dispensed at minimal cost to the patient while overcoming many of the barriers that may preclude or dissuade a patient from initially filling a prescription.

According to some example embodiments, a patient may be informed of the out-of-pocket cost to the patient after insurance, co-insurance, co-pay assistance benefits, and any other applicable benefits are applied, before the prescription is filled at the dispensing pharmacy 24. A patient may be contacted, for example, via communication interface 140 on their preferred mode of communication. The information regarding the out-of-pocket costs may be provided via phone call, via patient portal, via text message, via email, or however the patient has established that they would prefer to be informed of such information. The patient may be offered an opportunity to refuse the prescription or to proceed with the initial filling of the prescription. Alternatively, the method in which a patient refuses a prescription may be a multi-step process to dissuade a patient from making a snap judgement to refuse a prescription based solely on cost.

When a patient is informed about the out-of-pocket cost for a prescription, another option beyond accepting or declining the prescription may be offered, such as an offer for a supplemental insurance plan, a potential co-pay assistance benefit that was not compatible or could not be readily determined through the non-dispensing pharmacy 28, a financial aid application through one or more charities, or financing options, for example. In this manner, a patient may be afforded every opportunity to fill a prescription while preventing costs from being the only barrier.

While the aforementioned features relate to using a non-dispensing pharmacy 28 for overcoming financial barriers with respect to a first fill of a prescription, and removing complexity of a first fill of a prescription for a patient, example embodiments described herein may further provide additional adherence support services to eligible patients. Such services may include contacting a patient's preferred local pharmacy (which may be the same as the dispensing pharmacy 24) to ensure available stock for the prescribed product and provide loyalty program information that a pharmacist may apply to the patient's product refills.

In response to a prescription claim being processed at the non-dispensing pharmacy 28, the non-dispensing pharmacy may provide an alert to the dispensing pharmacy 24, whereby the non-dispensing pharmacy may ensure the accuracy of the applied co-pay claim, any co-pay offset benefits, and then contact the patient to arrange for delivery of their prescription to the patient. If, based on the patient information, additional reimbursement services are required prior to filling the prescription, the services and next steps may be discussed with a patient at that time. Services may include further benefit investigation such as securing prior authorization approvals from the physician and the patient's health insurance plan, step edits per a medication provider's business rules, or a service transfer to a pharmaceutical manufacturer's reimbursement service. An automated interface may enable timely management and help maintain service levels required to provide the patient with their first fill of medication in an expeditious manner.

Once a first fill of a prescription is successfully provided to a patient (either by pick-up or delivery), the patient may be given the opportunity to move their prescription to a preferred retail pharmacy for future fills. Alternatively, a patient may continue to have their prescription provided by the dispensing pharmacy 28 affiliated with the non-dispensing pharmacy 24 which will continue to apply co-pay offset benefits when processing subsequent refills as permitted by the rules of the co-pay program. The service application may leverage the technologies supporting the solution to complete the various requirements and the information and prescription transfers to the dispensing pharmacy or a retail pharmacy.

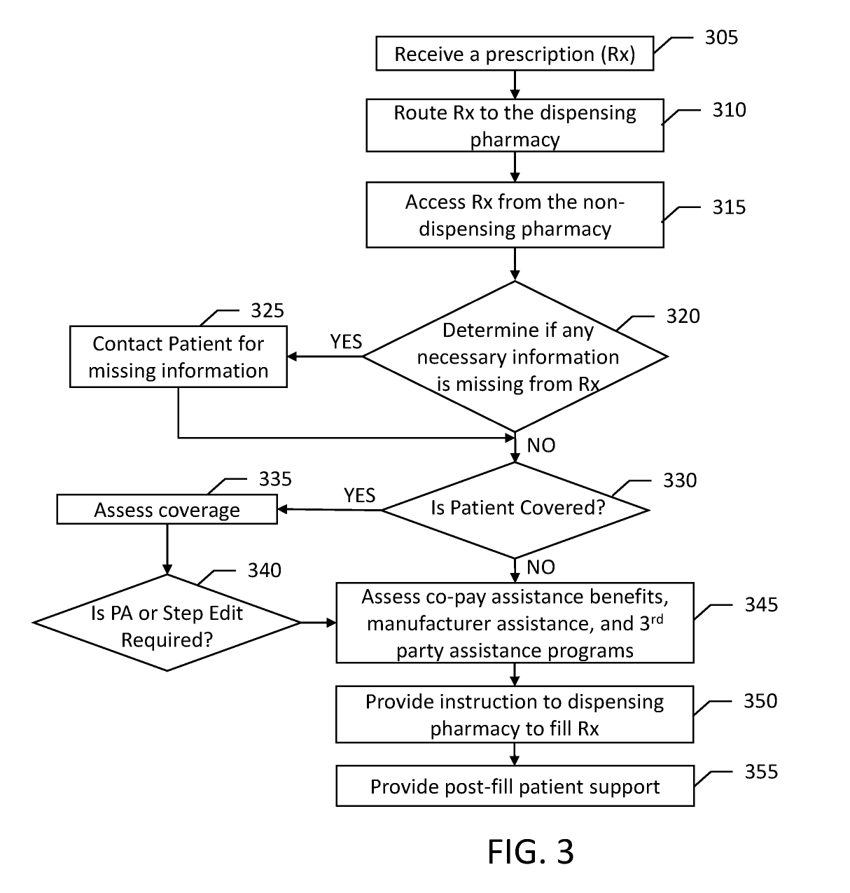

Embodiments of the present invention may therefore be practiced using an apparatus such as the one depicted in FIG. 2 within the overall system depicted in FIG. 1. However, it should be appreciated that some embodiments may be practiced in connection with a computer program product for performing embodiments of the present invention. FIG. 3 is a flowchart of a method and program product according to example embodiments of the invention. Each block of the flowchart of FIG. 3, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 120) and executed by processing circuitry (e.g., processor 110). The operations of FIG. 3 may define operations for the execution of an algorithm for improving the likelihood that a prescription will be filled by a patient. Furthermore, it should be noted that any of the operations of FIG. 3 may be repeated in some embodiments in order to define a cyclical mechanism by which repeated attempts at improving patient behavior in a targeted manner may be implemented.

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s). These computer program instructions may also be stored in a non-transitory computer-readable medium comprising memory that may direct a computer or other programmable apparatus to function in a particular manner, such that the instructions stored in the computer-readable memory produce an article of manufacture including instructions to implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

In this regard, a method according to one example embodiment of the invention, as shown in FIG. 3, may include receiving a prescription at 305. The prescription may be received by an EHR system, entered into an electronic ordering system, manually drafted and keyed into a system, or received into a fax machine, for example. The prescription may be routed to a dispensing pharmacy at 310. The dispensing pharmacy may be, for example, a retail pharmacy, as described above. The prescription information may be accessed from a non-dispensing pharmacy at 315 via a secure connection to ensure all information is held secure and in compliance with the Health Insurance Portability and Accountability Act (HIPAA). The apparatus of the non-dispensing pharmacy 28 may communicate with the apparatus of the dispensing pharmacy 24 to obtain the prescription information such that the non-dispensing pharmacy and the dispensing pharmacy are arranged in a unique symbiotic relationship. The non-dispensing pharmacy has direct, secured, remote access to the dispensing pharmacy's information system in support of a closely integrated, symbiotic relationship and operational model. The non-dispensing pharmacy may determine if any information necessary for fulfilling the prescription is missing from the prescription information at 320. In the event some information is missing, the patient may be contacted, as described above, at 325. Once the necessary information is obtained, or in the event that no additional information is needed for the prescription, the non-dispensing pharmacy may determine if the patient is covered for the prescribed medication at 330. If the patient is covered, the coverage may be assessed at 335 to determine the level and type of coverage provided. This operation may determine co-pay requirements for the coverage, in addition to whether prior authorization (PA) or a Step Edit may be required. A determination is made at 340 as to whether Prior Authorization or a Step Edit is required at 340. If so, the non-dispensing pharmacy may take on the actions necessary to complete the Prior Authorization, such as contacting the prescribing physician. If a Step Edit is necessary, the non-dispensing pharmacy may make the change to the prescribed medication regimen as necessary provided the Step Edit is approved for the patient.

The non-dispensing pharmacy may assess co-pay assistance benefits, manufacturer assistance, and third party assistance programs at 345 to determine how the out-of-pocket costs to a patient may be offset or reduced. Once complete, the known out-of-pocket costs may be provided to a patient via their preferred communication method and secure patient payment information. The non-dispensing pharmacy may then provide instruction to the dispensing pharmacy to fill the prescription at 350. Post-fill patient support, such as live-agent consultation, behavioral coaching, etc., may be provided at 355 to better ensure that a patient adheres to the prescribed medication regimen.

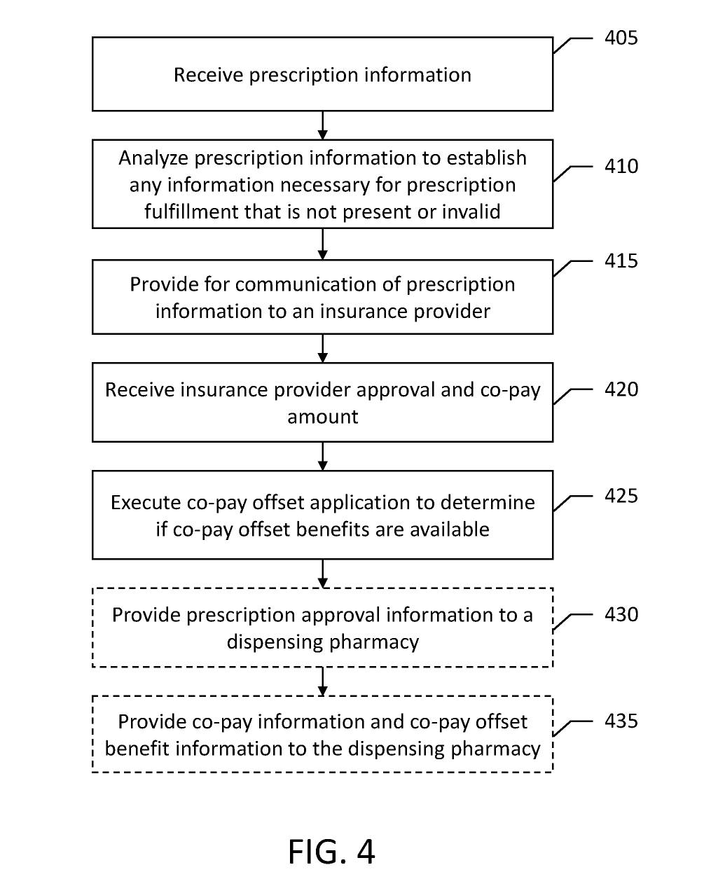

FIG. 4 illustrates a flowchart of a method according to another example embodiment of the present invention. According to the illustrated embodiment, prescription information may be received at 405. Prescription information may include, for example, an identification of the medication type, a dosage, and a patient identifier together with ancillary patient information. The prescription information may be analyzed at 410 to establish if any information necessary for fulfillment of the prescription is either missing or invalid. Information such as patient insurance provider, insurance patient number, date of birth, health or allergy information, prior authorization requirements, etc., may be reviewed to determine if anything is missing or incomplete. At 415, the prescription information may be communicated to an insurance provider to establish what costs are covered by the insurance, for example. A co-pay amount may then be received at 420 indicating the out-of-pocket expenses for the patient. At this point, a co-pay offset application may be executed to determine if co-pay offset benefits are available at 425. These co-pay offset benefits may be provided through the medication manufacturer, a third party insurer, a retail pharmacy, etc.

In some embodiments, certain ones of the operations above may be modified or further amplified as described below. Moreover, in some embodiments additional optional operations may also be included (some example of which is shown in dashed lines in FIG. 4). It should be appreciated that each of the modifications, optional additions or amplifications below may be included with the operations above either alone or in combination with any others among the features described herein. In some embodiments, the method may further include providing prescription approval information to a dispensing pharmacy as shown at 430, and providing co-pay information and co-pay offset benefit information to the dispensing pharmacy at 435.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A pharmaceutical prescription integration system comprising:
a dispensing pharmacy apparatus for receiving prescription information associated with a prescription from a care professional; and
a non-dispensing pharmacy apparatus configured to access the prescription information at the dispensing pharmacy;
wherein the non-dispensing pharmacy apparatus is configured to:
analyze the prescription information to determine any necessary information that is missing;
provide a request for any information determined to be missing;
communicate the prescription information to an insurance provider;
receive insurance provider approval and co-pay amount; and
execute a co-pay offset application to determine if co-pay offset benefits are available.

2. The system of claim 1, wherein the non-dispensing pharmacy apparatus is further configured to:
provide prescription approval information to the dispensing pharmacy; and
provide co-pay information and co-pay offset benefit information to the dispensing pharmacy.

3. The system of claim 2, wherein the non-dispensing pharmacy apparatus is further configured to:
provide a notification to the patient of out-of-pocket cost of the prescription and receive patient payment information.

4. The system of claim 1, wherein the prescription information comprises a medication name, a medication dosage, and patient information.

5. The system of claim 1, wherein the non-dispensing pharmacy apparatus is further configured to:
receive an indication that prior authorization is required for the prescription; and
provide communication to a care professional regarding the required prior authorization.

6. The system of claim 1, wherein the co-pay offset application analyzes the prescription information and determines if a third party entity program is available to pay for at least a portion of the co-pay.

7. The system of claim 1, wherein the non-dispensing pharmacy apparatus is further configured to provide confirmation to the dispensing pharmacy apparatus that the prescription is to be filled.

8. The system of claim 1, wherein the request for any information determined to be missing comprises providing a portal for entry of the information determined to be missing via a graphical user interface.

9. The system of claim 1, wherein the non-dispensing pharmacy apparatus is further configured to:
receive an indication of refusal from the insurance provider; and
provide authorization for an initial fill in response to the refusal from the insurance provider.

10. The system of claim 9, wherein in response to the indication of refusal from the insurance provider, the non-dispensing pharmacy apparatus is further configured to:
provide an indication to a third party service of the refusal from the insurance provider; and
receive from the third party service an indication of an amount of assistance available to offset a cost of the prescription.

11. A method for completing a first fill of a prescription comprising:
receiving prescription information including an identification of the medication type, a dosage, a patient identifier;
analyzing prescription information to establish any information necessary for prescription fulfillment that is not present or invalid;
providing for communication of prescription information to an insurance provider;
receiving insurance provider approval and co-pay amount; and
executing a co-pay offset application to determine if co-pay offset benefits are available.

12. The method of claim 11, further comprising:
providing prescription approval information to a dispensing pharmacy; and
providing co-pay information and co-pay offset benefit information to a dispensing pharmacy.

13. The method of claim 11, further comprising:
providing a notification to a patient associated with the patient identifier of a need for additional information in response to establishing at least some information necessary for prescription fulfillment is not present or invalid.

14. The method of claim 13, wherein the notification comprises a portal through which the patient may provide the additional information.

15. The method of claim 11, further comprising:
providing a notification to the patient of out-of-pocket cost of the prescription and receiving patient payment information.

16. The method of claim 11, further comprising:
receiving an indication that prior authorization is required for the prescription; and
providing communication to the care professional regarding the required prior authorization.

17. An apparatus comprising at least one processor and at least one non-transitory memory having computer program code stored thereon, the apparatus configured, in response to execution of the program code, to:
receive prescription information associated with a prescription, wherein the prescription information comprises at least a patient identifier and a medication identifier;
determine if any information needed for fulfilling the prescription is not present in the prescription information;
provide an indication to an insurance provider associated with the patient identifier of the prescription information;
receive an indication from the insurance provider regarding eligibility and co-pay amount;
assess co-pay assistance benefits of one or more third party assistance programs; and
provide instruction to a dispensing pharmacy to fill the prescription.

18. The apparatus of claim 17, wherein the apparatus is further configured to:
provide a notification to the patient in response to any information needed for fulfilling the prescription not being present in the prescription information.

19. The apparatus of claim 17, wherein the apparatus is further configured to:
provide an indication to the patient of an out-of-pocket cost associated with the prescription in response to the co-pay amount provided by the insurance provider and the co-pay assistance benefits of the one or more third party assistance programs.

20. The apparatus of claim 17, wherein the apparatus is further configured to:
receive an indication from the insurance provider that prior authorization is required for the prescription; and
provide communication to a health care professional regarding the required prior authorization.
